(19) United States
(12) Patent Application Publication
(10) Pub. No.: US 2024/0416285 A1
(43) Pub. Date: Dec. 19, 2024

(54) COMPACT WATER FILTERING DEVICE

(71) Applicant: PURIFIER d.o.o., Zagreb (HR)

(72) Inventors: Laszlo SIPOS, Zagreb (HR); Marinko MARKIC, Zagreb (HR); Marko BAUS, Zagreb (HR)

(73) Assignee: PURIFIER d.o.o., Zagreb (HR)

(21) Appl. No.: 18/820,839

(22) Filed: Aug. 30, 2024

Related U.S. Application Data
(63) Continuation of application No. PCT/EP2022/055323, filed on Mar. 2, 2022.

(51) Int. Cl. B01D 61/10; B01D 61/04; B01D 61/08; B01D 61/16; B01D 61/18; B01D 61/20; C02F 1/00; C02F 1/44; F04B 19/04; F04B 53/20

(52) U.S. Cl. CPC B01D 61/10; B01D 61/04; B01D 61/08; B01D 61/16; B01D 61/18; B01D 61/20; C02F 1/002; C02F 1/441; C02F 1/442; C02F 1/444; F04B 19/04; F04B 53/20; B01D 2311/04; B01D 2311/08; B01D 2313/18; B01D 2313/243; C02F 2201/005; C02F 2301/046

(57) ABSTRACT

A water filtering device can comprise: a filter, an optional prefilter, and two stages pumping system with recirculation circuit is disclosed. The pumping system is formed with two pistons, merged together where the recirculation piston is further equipped with at least one non-return valve. During the intake phase, the chambers are filed through the pair of non-return valves, while the concentrate and the feedwater are mixed through the non-return valve. During the compression, the valve is closed, and the pressure generated by the piston within the chamber is transmitted to the chamber and subsequently towards the filtering means. Permeate is extracted out while the concentrate is sent to the chamber by the recirculation. The system can achieve pressure sufficient for ultrafiltration, nanofiltration or reverse osmosis of any water type available.

### CROSS-REFERENCE TO RELATED APPLICATION(S)

The present application is a continuation of International Patent Application No. PCT/EP2022/055323, filed Mar. 2, 2022, wherein the contents and disclosure of which are hereby incorporated by reference in their entirety.

### TECHNICAL FIELD

The present disclosure relates to a water filtering device and systems and methods thereof.

### BACKGROUND

Two kinds of technical solutions were observed in the related prior art. First, where manpower, or external force, acting via piston or similar device directly onto the liquid that is subjected to the filtration; and second—where a manpower increases air pressure acting as a buffer on the liquid that is subjected to filtration. The latter may not be suitable for the filtration processes at elevated pressures, for instance, due to increased dissolution/release processes of the air in liquid and/or explosion hazards of the compressed air.

European patent published as EP3250514B1 for PERSONAL WATER FILTER DEVICE, by SIPOS, Laszlo et al., describes a personal water purification device using a membrane type filtration with almost constant high-pressure exerted to the membrane filter during the operation, and with recirculation ability in one of the described embodiments.

German patent application published as DE2850663A1 for GERÄT ZUR DURCHFÜHRUNG DER UMKEHROSMOSE, by Hestermann G. describes embodiments of a reverse osmosis filtration device. According to the abstract of '663, each embodiment has a large flushing and small pressure producing piston.

Another document, the Chinese utility model published as CN203043686U for PORTABLE PRESSURE WATER PURIFIER, by Yang Cheng et. al., describes a personal water purification system with two cylinders. The pressure in the system varies from the atmospheric pressure to some maximum pressure allowable with the construction between strokes, i.e., limited by the sealing means used herewith, and no recirculation ability is understood to be mentioned.

A one-cylinder solution is described by the German utility model published as DE202005018578U1 for DE-ENERGIZED PUMP IN COMBINATION WITH DIAPHRAGM MODULE FOR SEPARATION . . . , by Kaifel R. No recirculation ability is understood to be mentioned.

International PCT patent application published as WO2007/028044A1 DUAL STAGE ULTRAFILTER DEVICES IN THE FORM OF PORTABLE FILTER DEVICES, SHOWER DEVICES, AND HYDRATION PACK, by Collins G. R. et. al., describes dual stage ultrafilter devices in the form of portable filter devices, shower devices, and hydration packs. The cited device may be regarded as an ultrafilter cartridge apparatus that offers two filtration stages, normal and redundant filtration—within a single housing. Redundant filtration or second filtration operation is performed on the filtered water to ensure that a water discharged from the device is sterile and suitable for use. This reference, however, is not understood to describe recirculation possibility.

International PCT patent application published as WO2008/101159A1 COMPACT FLUID PURIFICATION DEVICE WITH MANUAL PUMPING MECHANISM, by Collins G. R. et. al., describes a fluid purification device with a manual pumping mechanism. In another embodiment, two stage filtration is proposed in a way that fluid is propelled within the same reciprocal motion cycle across both filtration stages. This reference, however, is not understood to describe recirculation possibility.

US patent published as U.S. Pat. No. 7,438,801 for COMPACT PERSONAL WATER PURIFICATION DEVICE, by Scaringe R. J., describes a personal water purification device where the pumping means is not understood to form a part of the filtration means. A symmetrical reverse osmosis membrane coupled with a pre-filter is used to remove salt and impurities from the raw water. The cited one-stage filtration means, however, may be regarded as being without recirculation possibility.

The patent application published as GB2473836 for WATER FILTER, by Griffith J., describes a system and method of removing bacteriological contaminants from water that comprises a pre-filter, a pump, a hollow fiber membrane module, and a clean water outlet.

### SUMMARY

According to one or more aspects a compact water filtering device can comprise: a filter within a recirculation chamber; one or more prefilters; and a two-stage pumping system with a recirculation concentrate circuit, where the filter, the one or more prefilters, and the two-stage pumping system are mounted within a casing and an inner casing, wherein the two-stage pumping system consists of a water inlet equipped with an inlet non-return valve, to allow the water passage to an intake chamber only, where the intake chamber changes its volume by action of a high-pressure piston which is driven by an outer force, wherein the high-pressure piston has a piston non-return valve mounted in its forehead, to allow the water passage across a high-pressure piston conduit into a compression chamber, wherein a recirculation piston having a larger operating area than that the high-pressure piston to which is attached and is moveable simultaneously with it, where the recirculation piston divides the space of an inner casing wall into two chambers, the compression chamber situated beneath the recirculation piston and an upper chamber situated above the recirculation piston, wherein the recirculation piston has one or more non-return valves to allow the water passage from the upper chamber to the compression chamber, wherein simultaneous stroke-up of the recirculation piston and the high-pressure piston causes the intake of the water into the intake chamber through the inlet non-return valve and simultaneous decrease of the upper chamber volume, wherein simultaneous stroke-down action of the recirculation piston and the high-pressure piston causes an increasing of the intake chamber pressure and the water from the intake chamber is injected through the piston non-return valve and the high-pressure piston conduit into the compression chamber which volume is lowering due to the recirculation piston movement that forces a water flow from the compression chamber across the one or more prefilters and the filter, causing at the same time an intake of the concentrate from the recirculation chamber into the upper chamber, wherein the upper chamber is further equipped with a concentrate discharge valve, and wherein a permeate is guided out of the filter by a permeate drainage to the permeate outlet.

According to one or more aspects, a method can comprise: providing a water filtering system including: a filter within a recirculation chamber; one or more prefilters (which can be optional); and a two-stage pumping system with a recirculation concentrate circuit, where the filter, the one or more prefilters, and the two-stage pumping system are mounted within a casing and an inner casing, wherein the two-stage pumping system includes a water inlet equipped with an inlet non-return valve, to allow the water passage to an intake chamber only, where the intake chamber changes its volume by action of a high-pressure piston which is driven by an outer force, wherein the high-pressure piston has a piston non-return valve mounted in its forehead, to allow the water passage across a high-pressure piston conduit into a compression chamber, wherein a recirculation piston having a larger operating area than that the high-pressure piston to which is attached and is moveable simultaneously with it, where the recirculation piston divides the space of an inner casing wall into two chambers, the compression chamber situated beneath the recirculation piston and an upper chamber situated above the recirculation piston, wherein the recirculation piston has one or more non-return valves to allow the water passage from the upper chamber to the compression chamber, wherein simultaneous stroke-up of the recirculation piston and the high-pressure piston causes the intake of the water into the intake chamber through the inlet non-return valve and simultaneous decrease of the upper chamber volume, wherein simultaneous stroke-down action of the recirculation piston and the high-pressure piston causes an increasing of the intake chamber pressure and the water from the intake chamber is injected through the piston non-return valve and the high-pressure piston conduit into the compression chamber which volume is lowering due to the recirculation piston movement that forces a water flow from the compression chamber across the one or more prefilters and the filter, causing at the same time an intake of the concentrate from the recirculation chamber into the upper chamber, wherein the upper chamber is further equipped with a concentrate discharge valve, and wherein a permeate is guided out of the filter by a permeate drainage to the permeate outlet.

### BRIEF DESCRIPTION OF FIGURES

FIG. 1 depicts a longitudinal cross-section of a cylindrical water filtering device where the recirculation piston is equipped with one or more non-return valves, according to one or more embodiments of the present disclosure.

FIG. 1A depicts a cross-section of the cylindrical water filtering device where the recirculation piston is formed without non-return valves, according to one or more embodiments of the present disclosure.

FIG. 2 shows the hydraulic scheme of the variant depicted on FIG. 1 according to one or more embodiments of the present disclosure.

FIG. 2A shows the hydraulic scheme of the variant depicted on FIG. 1A according to one or more embodiments of the present disclosure.

### DETAILED DESCRIPTION

The present disclosure may be regarded as relating to a compact water filtering device, capable of being carried around, where the water treatment is performed by the membrane type filtration, and systems, methods, and portions thereof.

One of the world's biggest problems is the lack of clean drinking water due to an increasing pollution and industrialization which may not be followed by adequate systems for water treatment.

Globally, approximately 90% of people have access to water from a source that may be regarded as suitable for drinking—called improved water source. In sub-Saharan Africa, for instance, access to potable water ranged from 40% to 80% of the population. Nearly 4.2 billion people worldwide have access to tap water, while another 2.4 billion have access to wells or public taps. The World Health Organization considers access to safe drinking-water as a basic human right. About 1 to 2 billion people lack safe drinking water.

There are several generally accepted technological processes for producing potable water for residential supply. At the same time, there are only a handful of portable products fit for personal drinking water supply. These products usually differ by the device volume, purification efficiency and capacity.

A technical problem solved by one or more embodiments of the present disclosure can be in compactness, while achieving suitable filtration properties, i.e., by keeping constant pressure exerted to the membrane filter during the operation of the water filtering device. According to one or more embodiments, the entire device may be formed as a one-cylinder device with a multi-stage (e.g., two-stage) pumping system built into, for instance, with no significant pressure drop between pumping strokes in the membrane region.

An additional or alternative technical problem that may be solved in one or more embodiments of the present disclosure can be the way of increasing concentrate flow rate across a membrane filter by recirculation which does not affect compactness. This may be regarded as a direct corollary of the first technical problem. Further, by recirculation the present disclosure can mean the circulation back and forth through a filter (e.g., a filtration unit). Such recirculation can effectively decrease the concentration of the retained substances at the membrane surface, which can decrease the osmotic pressure, followed by additional increases of the filter effectiveness.

For normal operation, a personal water purification device, according to one or more embodiments of the present disclosure, may need power. According to or more embodiments according to the present disclosure, the device can be designed to use manpower for reciprocal motion of the pistons (e.g., as a primary design), however, any auxiliary device producing the reciprocal motion can be equally used.

The technical field of the disclosure can be regarded as treatment of water, wastewater, sewage, or sludge where the filtration techniques may play an important role. More precisely, one or more embodiments of the present disclosure can be related to devices (or systems or methods thereof) with portable filters for producing potable water, e.g., for personal travel or emergency equipment, survival kits, combat gears, and where the water treatment can be performed by filtration, osmosis, and/or reverse osmosis.

One or more embodiments of the present disclosure can thus be regarded as relating to a compact water filtering device, capable to be carried around, where the water treatment can be performed by membrane type filtration.

One or more embodiments of the present disclosure can be directed to or involve a compact water filtering device which can comprise a filter (e.g., filtering means) which can be situated within a recirculation chamber, an optional prefilter, and a multi-stage (e.g., two stages) pumping system with a recirculation concentrate (C) circuit. The mentioned parts may be mounted within a casing and an inner casing which integrate and hold the mentioned parts.

A multi-stage (e.g., two stages) pumping system, according to one or more embodiments of the present disclosure, may comprise or consist of a water inlet, equipped with an inlet non-return valve, configured to allow the water passage to an intake chamber only. The intake chamber can change its volume by the action of a piston (e.g., high-pressure piston) which can bedriven by the outer force. The piston can have a non-return valve mounted in its forehead, which can be configured to allow the water passage across a high-pressure piston conduit into a compression chamber.

A recirculation piston can be dimensioned to have larger operating area that the high-pressure piston to which is firmly attached and moves simultaneously with it. The recirculation piston can divide the space of an inner casing wall into two chambers—the compression chamber situated beneath the recirculation piston and an upper chamber situated above the recirculation piston.

The recirculation piston can optionally be equipped with one or more non-return valves configured to allow the water passage from the upper chamber to the compression chamber.

The recirculation piston and the high-pressure piston simultaneous stroke-up can cause the intake of the water into the intake chamber through the inlet non-return valve. This action can simultaneously decrease the upper chamber volume.

When the recirculation piston and the high-pressure piston simultaneous stroke-down, this action can cause an increasing of the intake chamber pressure and the water from the intake chamber can be injected through the piston non-return valve and the high-pressure piston conduit into the compression chamber. Also, the compression chamber volume can be lowering due to the recirculation piston movement, which can force a water to flow from the compression chamber to optional prefilters and the filter (e.g., filtering means). That action can also cause an intake of the concentrate (C) from the recirculation chamber into the upper chamber.

The upper chamber may be further equipped with a concentrate (C) discharge valve, and a permeate (P) can be guided out of the filter (e.g., filtering means) by a permeate drainage to the permeate outlet.

In one modification, the recirculation piston can be formed without non-return valves. During the stroke-up movement, the recirculation piston can empty the upper chamber and can force a reverse circulation through the membrane and the prefilter back to the compression chamber.

In another modification, the recirculation piston can be equipped with one or more non-return valves which can equalize the pressure between the compression chamber and the upper chamber, during the stroke-up movement. According to one or more embodiments, one or more non-return valves can be formed as elastic flaps attached to the recirculation piston's side facing to the compression chamber, where the elastic flaps can be positioned over the openings made through the recirculation piston.

According to one or more embodiments of the present disclosure, the filter can be or include a membrane selected from the membranes suitable for ultrafiltration, nanofiltration, or reverse osmosis.

Optionally, a prefilter can be present and selected from a cellulose, a cotton, or a glass wool, as well as granular activated carbon, a zeolite or other suitable porous filer material, or their combinations.

In one, some, or all disclosure variants, the inlet non-return valve can be situated at the end of the water inlet, close to the intake chamber, for instance, to allow the most effective compression performed by the high-pressure piston within the intake chamber which is formed inside the inner casing. The inner casing can have one or more recirculation apertures formed in the upper chamber that connects the upper chamber and the recirculation chamber formed over the filter. That can allow the concentrate (C) to be circulated back into the upper chamber, and to be eventually mixed with the fresh water from the compression chamber during the stroke-up phase. The concentrate discharge valve can be set to discharge the concentrate (C) from the device once the desired pressure is reached within the upper chamber.

According to one or more embodiments, all the chambers and the pistons can have a circular cross-section.

The compact water filtering device according to one or more embodiments of the present disclosure, and systems and methods thereof, can be suitable for ultrafiltration, nanofiltration or reverse osmosis any of tap water, surface water, groundwater, seawater, or wastewater. Optionally, the operating outer force can be generated by a manpower, or, by an electric or a hydraulic source.

In this section only the “vertical system” will be discussed, i.e., the system where the cylindric body and the high-pressure piston are being positioned perpendicular to the ground and where the outer force (80) acts from the above to the device. The device, however, can additionally or alternatively operate in horizontal position or any other inclined position by allowing the permeate (P) to be carried out from the filtering device and to assure the proper position for the concentrate discharge valve.

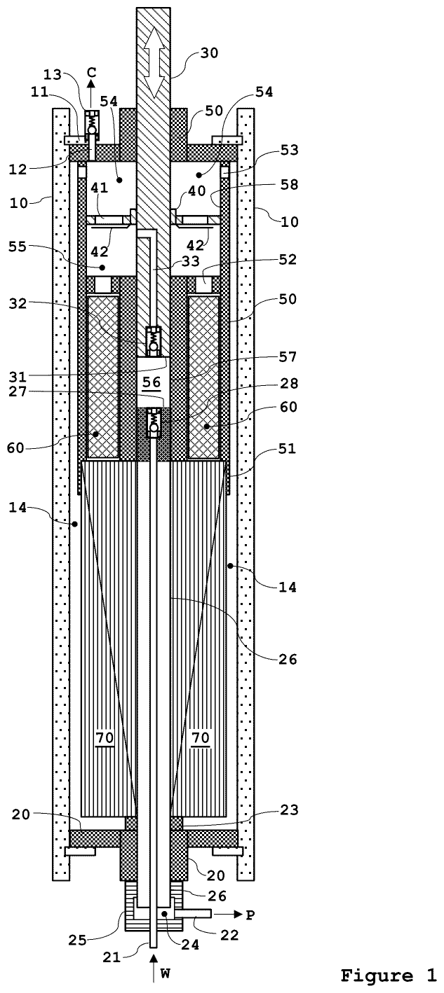

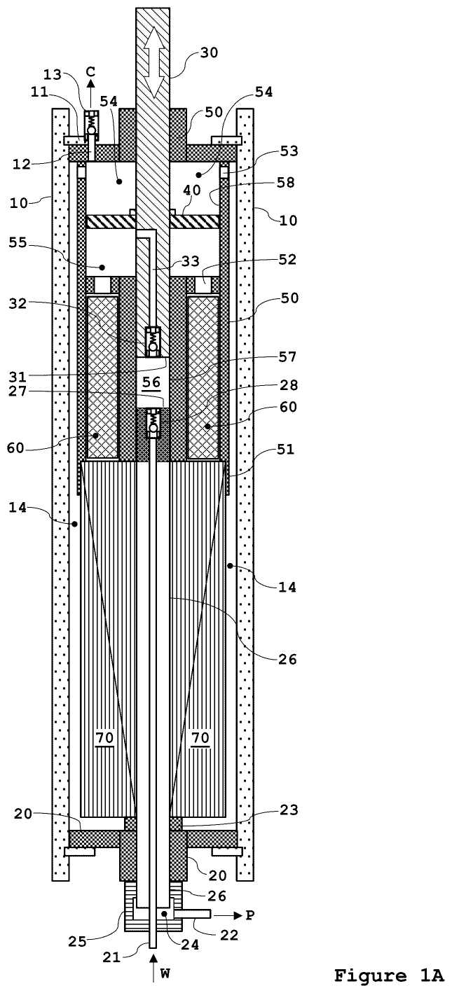

The longitudinal cross-section of compact water filtering device, according to one or more embodiments of the present disclosure, formed as the “vertical system,” is shown on FIG. 1. The cylindrical casing (10) can be configured to enclose and to connect all parts of the device. Other geometries may also be implemented, i.e., geometries that differs from cylindrical, but in this description only the cylindrical variant is discussed. The casing (10) can be formed of metal, though any other suitable material capable to endure the inner pressure can be equally used for the casing (10) and for all parts described below.

The casing (10) can have the base (20) at its bottom, and the inner casing (50) situated opposite of the base (20), secured by the stopper (11). The base (20) and the inner casing (50) can connect all other parts used in this device and render this device functional. The water filtering device, according to one or more embodiments of the present disclosure, may have only one part movable within the inner casing (50), e.g., the high-pressure piston (30) that is shaped as the cylinder rod to which is firmly attached the recirculation piston (40) of greater diameter. The high-pressure piston (30) part that exits from the inner casing (50) can be formed as the metal rod to which the outer driving force (80) is applied. This outer driving force may be generated by a manpower, or, by an electric or a hydraulic source. It should be noted that the high-pressure piston (30) part should be properly sealed within the inner casing (50), e.g., to avoid any fluid losses among the parts that relatively moves one to another, which, optionally, may be a prerequisite for a device one or more embodiments of to work.

The inner casing (50) can be of cylindric shape. On its top, the inner casing (50) can fit (e.g., sealingly fit) to the casing (10) diameter and can have the appropriately sealed passage for the high-pressure piston (30) in its centre. The inner casing (50) body can be shaped as a cylindrical part that fits (e.g., loosely fits) the casing (10), with a membrane fixer (e.g., membrane fixing means) (51) formed at the opposite end. This membrane fixer (51) can be shaped as the fins for fitting over the filter (e.g., filtering means) (70) in order to secure it centrally within the casing (10). The filter (70) is a membrane selected from the membranes suitable for ultrafiltration, nanofiltration or reverse osmosis. The space between inner casing (50), filter (70) and the casing (10) can form the recirculation chamber (14), such as depicted in FIG. 1. In addition, the central bottom part of the inner casing (50) can be formed as the cylindrical inner chamber wall (57) to which the high-pressure piston (30) can fits (e.g., sealingly fit), i.e., with the exact the same diameter. The inner chamber wall (57) can form a cylinder that may also serve as the guide for the high-pressure piston (30) while moves up and down within the inner casing (50).

Approximately in its lower part, the inner casing (50) can be equipped with one or more filter conduits (52) which can be configured to allow the water passage towards one or more built in prefilters (60), and then towards the filter (70). A role of the prefilters (60) can be to act as the first filtration step in chemical sense, and as a mechanical barrier that can protect the filter (70). The prefilters (60) can be formed from a cellulose, a cotton, or a glass wool, as well as granular activated carbon, a zeolite or other suitable porous filer material, or their combinations.

The inner casing (50) can be equipped with one or more recirculation apertures (53) formed close to the inner casing's top. The apertures (53) can allow the water passage from the recirculation chamber (14) towards the upper chamber (54) and vice versa, i.e., the chamber formed over the recirculation piston (40). The recirculation piston (40) may divide the inner upper space of the casing (50) into the upper chamber (54), formed above the recirculation piston (40), and the compression chamber (55) formed beneath the recirculation piston (40), between the piston (40) and the filter conduits (52), such as shown in FIG. 1. The recirculation piston (40) can have the diameter that fits (e.g., sealingly) within the inner diameter of the upper part of inner casing (50), while being firmly attached to the high-pressure piston (30).

The upper chamber (54) can be connected, via the concentrate drain (12) formed in the inner casing (50), with the concentrate discharge valve (13). The discharge valve (13) can be a check valve that can be adjusted to be opened if the pressure within the recirculation chamber (14) connected with the upper chamber (54) through one or more recirculation's apertures (53) surpasses the desired pressure value.

In addition, it can be opened manually to serve as the exhaust for the residual device's air, according to one or more embodiments of the present disclosure.

According to one or more embodiments of the preferred disclosure, the recirculation piston (40) can be equipped with one or more non-return valves (42) configured to allow the water passage from the upper chamber (54) to the compression chamber (55) only. In this embodiment, the non-return valves (42) can be formed from the elastic flaps (42), which can be attached on one end to the recirculation piston (40). The flaps (42) can seat over the recirculation piston openings (41) that can be formed as bores through the recirculation piston (40). When recirculation piston (40) lowers the volume of the upper chamber (54), part of the water situated in the upper chamber (54) can pass through the flaps (42) into the compression chamber (55). In the opposite case, when the recirculation piston (40) lowers the compression chamber (55) volume, the flaps (42) can seal the openings (41) and block the water passage back to the upper chamber (54), so the water is forced to flow towards the filter conduits (52).

Regarding the high pressure piston (30) according to one or more embodiments of the present disclosure, Although being designed as the constant cross-section rod, at its bottom part, i.e., immediately at the piston forehead (31), it can be equipped with the non-return valve (32). Furthermore, the piston conduit (33), formed across the piston (30), can connect the non-return valve (32) and the compression chamber (55). A role of the non-return valve (32) can be to allow the water passage from the intake chamber (56), which can be defined by the stationary inner chamber wall (57), towards the compression chamber (55) only, i.e., while the high-pressure piston (30) is moving in a way to lower the intake chamber (56) volume. When the high-pressure piston (30) is moving in the opposite direction, i.e., out of the casing (10), the non-return valve (32) can remain closed.

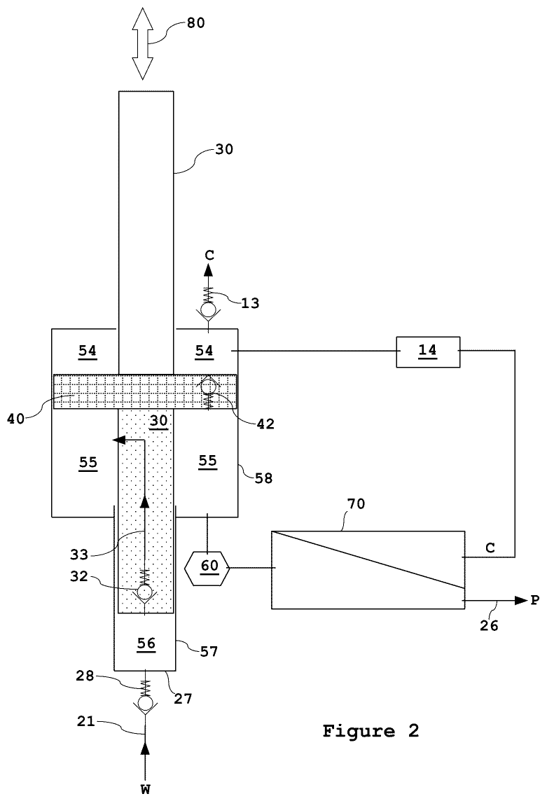

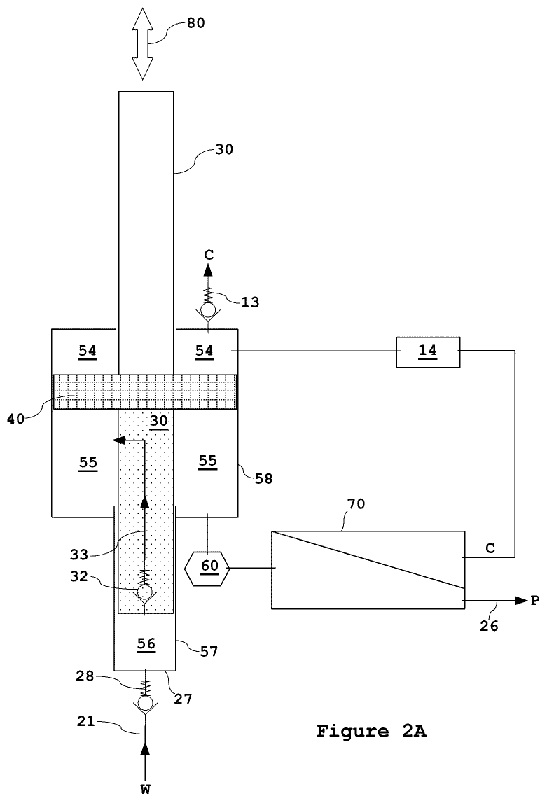

The intake chamber (56), as mentioned before, can be defined by the stationary inner chamber wall (57), the moving piston forehead (31), and with the bottom of the intake chamber (27). The bottom of the intake chamber (27) can be formed as the plug inserted centrally into the inner casing (50) in which another inlet non-return valve (28) is additionally fitted. This inlet non-return valve (28) can be connected with the water inlet (21), where symbol (W) denotes water, or row-water that has to be filtered. The water inlet (21) can be configured to pass through the permeate (P) drainage (26) and the bottom plug (25) situated at the base (20)—out of the device, such as depicted on FIGS. 1 and 2.

A look at the bottom of the device can reveal the base (20) which can be equipped with the centrally positioned bottom membrane fixer (23) which, together with the fixer (51), can hold the filter (70) positioned centrally to the casing (10). The permeate drainage (26) can also help in this process being positioned centrally across the filter (70) and stiffens the filter (70) within its position in the casing (10).

The permeate drainage (26) can be formed as a hollow cylinder. Numerous slits or holes on the drainage (26) mantle can be implemented, for instance, to allow the permeate (P) generated in the filtering process to be collected within its interior. From its interior, the permeate (P) can be transported, by the gravity force, towards the permeate chamber (24) formed within the bottom plug (25). The permeate outlet (22) can then drain the purified water, i.e., the permeate (P) out of the permeate chamber (24).

One difference among the embodiments depicted via FIGS. 1 and 1A can be that the second embodiment can be formed without non-return valves (42) over the recirculation piston (40). FIGS. 2, 2A show the hydraulic schemes of the variants depicted on FIGS. 1, 1A.

### Operation of the First Embodiment

It may be instructive to check FIG. 2 for discussion how the first embodiment operates.

The lowest position of the high-pressure piston (30) can be taken as the initial position for discussion, i.e., when the intake chamber (56) has its lowest volume. When high-pressure piston (30), together with the recirculation piston (40), stroke-up, the non-return valve (28) can be opened, and the polluted water (W) can start to fill the compression chamber (56). At the same time the non-return valve (32) situated within the high-pressure piston (30) can be closed. Action of the recirculation piston (40) can lower the volume of the upper chamber (54) and can expand the volume of the compression chamber (55). One or more check-valves (42), which may be situated on the recirculation piston (40), can be opened which produces two effects, one is equalisation the pressure between the compression chamber (55) and the upper chamber (54), which can depend on check-valves (42) characteristics. The second process can be that the mentioned action starts the recirculation of the liquid in the chain: the upper chamber (54)—the recirculation chamber (14)—the filter (70)—the prefilter (60)—and back towards the compression chamber (55).

Now, when the recirculation piston (40) and the high-pressure piston (30) start stroke-down from the uppermost position, when the volume of the upper chamber (54) is smallest, the following chain of actions can occur. The high-high pressure piston (30) can start to compress the intake chamber (56). This action can generate the water pressure that opens the piston non-return valve (32) and can increase the pressure within the compression chamber (55) that can be sealed by the recirculation piston (40) from the above, and the prefilter (60) and filter (70) from below. Simultaneously, all the water situated within the compression chamber (55) can be compressed additionally by the action of the recirculation piston (40). The latter can result in two processes. One, the water can be forced to pass the prefilter (60), the filter (70), then the concentrate (C) can pass recirculation chamber (14) and finally end in the upper chamber (54). The fraction of the water can pass the filter (70) and end in the permeate (P) drainage (26) from where is extracted out of the device.

### Operation of the Second Embodiment

It may be instructive to check FIG. 2A for the discussion how the second embodiment operates.

The lowest position of the high-pressure piston (30) can be taken as the initial position for discussion, i.e., when the intake chamber (56) has its lowest volume. When high-pressure piston (30), together with the recirculation piston (40), stroke-up, the non-return valve (28) can be opened, and the polluted water (W) can start to fill the compression chamber (56). At the same time the non-return valve (32), which can be situated within the high-pressure piston (30), can be closed. Action of the recirculation piston (40) can lower the volume of the upper chamber (54) and expand the volume of the compression chamber (55). The process can start the recirculation of the liquid in the chain: the upper chamber (54)—the recirculation chamber (14)—the filter (70)—the prefilter (60)—and finally the compression chamber (55). In contrast to the first embodiment, there may be no mixing of liquids through the recirculation piston (40).

However, the stroke-down process may be identical as in the first embodiment.

It may also be worth noting once again that the pressure within the recirculation line, i.e., the upper chamber (54)—the recirculation chamber (14)—the filter (70)—the prefilter (60)—the compression chamber (55) can remain almost constant between the strokes in both embodiments. This can yield to a better filtration process. Furthermore, the recirculation of the concentrate (C) forth and back, especially in the second embodiment, can rise the filter (70) efficacy per stroke.

A role of the concentrate discharge valve (13) can be to allow the pressure relief and discharge of the concentrate (C) if it is too saturated with the pollution which can render the recirculation process poor. A role of the discharge valve (13) can be to allow the residual air to be removed from the device during the few first intakes, i.e., strokes when the air within the device is entirely substituted with the liquid.

Filtering devices according to one or more embodiments of the present disclosure can be capable to produce average pressure within the recirculation line of at least 60 Bar with the deviation of approximately 10 Bar (in plus and minus) during the strokes.

### INDUSTRIAL APPLICABILITY

The present disclosure may be regarded as relating to compact water filtering device and systems and methods thereof for producing potable water, e.g., personal travel or emergency equipment, survival kits, combat gear; where the water treatment is performed by filtration, osmosis, or reverse osmosis.

1. A compact water filtering device comprising:
a filter within a recirculation chamber;
one or more prefilters; and
a two-stage pumping system with a recirculation concentrate circuit, where the filter, the one or more prefilters, and the two-stage pumping system are mounted within a casing and an inner casing
wherein the two-stage pumping system consists of a water inlet equipped with an inlet non-return valve, to allow the water passage to an intake chamber only, where the intake chamber changes its volume by action of a high-pressure piston which is driven by an outer force,
wherein the high-pressure piston has a piston non-return valve mounted in its forehead, to allow the water passage across a high-pressure piston conduit into a compression chamber,
wherein a recirculation piston having a larger operating area than that the high-pressure piston to which is attached and is moveable simultaneously with it, where the recirculation piston divides the space of an inner casing wall into two chambers, the compression chamber situated beneath the recirculation piston and an upper chamber situated above the recirculation piston,
wherein the recirculation piston has one or more non-return valves to allow the water passage from the upper chamber to the compression chamber,
wherein simultaneous stroke-up of the recirculation piston and the high-pressure piston causes the intake of the water into the intake chamber through the inlet non-return valve and simultaneous decrease of the upper chamber volume,
wherein simultaneous stroke-down action of the recirculation piston and the high-pressure piston causes an increasing of the intake chamber pressure and the water from the intake chamber is injected through the piston non-return valve and the high-pressure piston conduit into the compression chamber which volume is lowering due to the recirculation piston movement that forces a water flow from the compression chamber across the one or more prefilters and the filter, causing at the same time an intake of the concentrate from the recirculation chamber into the upper chamber,
wherein the upper chamber is further equipped with a concentrate discharge valve, and
wherein a permeate is guided out of the filter by a permeate drainage to the permeate outlet.

2. The compact water filtering device according to claim 1, wherein the recirculation piston is formed without non-return valves, and during the stroke-up movement the recirculation piston empties the upper chamber and forces a reverse circulation through the membrane and the one or more prefilters back to the compression chamber.

3. The compact water filtering device according to claim 1, wherein the recirculation piston is equipped with one or more non-return valves which equalise the pressure between the compression chamber and the upper chamber, during the stroke-up movement.

4. The compact water filtering device according to claim 2, wherein one or more non-return valves are formed as elastic flaps attached to the recirculation piston's side facing to the compression chamber, where the elastic flaps are positioned over the openings made through the recirculation piston.

5. The compact water filtering device according to claim 1, wherein the filter is or includes a membrane selected from the membranes suitable for ultrafiltration, nanofiltration, or reverse osmosis.

6. The compact water filtering device according to claim 1, wherein each of the one or more prefilters is selected from cellulose, cotton or glass wool, as well as granular activated carbon, zeolite or another porous filer material, or their combinations.

7. The compact water filtering device according to claim 1, wherein the inlet non-return valve is situated at the end of the water inlet, close to the intake chamber, to allow effective compression performed by the high-pressure piston within the intake chamber which is formed inside the inner casing.

8. The compact water filtering device according to claim 1, wherein the inner casing has one or more recirculation apertures formed in the upper chamber, that connects the upper chamber and the recirculation chamber formed over the filter for allowing the concentrate to be circulated back into the upper chamber.

9. The compact water filtering device according to claim 1, wherein the concentrate discharge valve is set to discharge the concentrate from the filtering device once the desired pressure is reached within the upper chamber.

10. The compact water filtering device according to claim 1, wherein all the chambers and the pistons have a circular cross-section.

11. Use of the compact water filtering device according to claim 1, for ultrafiltration, nanofiltration, or reverse osmosis any of tap water, surface water, groundwater, seawater, or wastewater.

12. Use of the compact water filtering device according to claim 10, wherein the operating outer force is generated by a manpower, or, by an electric or a hydraulic source.

13. A method comprising:
providing a water filtering system including:
a filter within a recirculation chamber;
one or more prefilters; and
a two-stage pumping system with a recirculation concentrate circuit, where the filter, the one or more prefilters, and the two-stage pumping system are mounted within a casing and an inner casing,
wherein the two-stage pumping system includes a water inlet equipped with an inlet non-return valve, to allow the water passage to an intake chamber only, where the intake chamber changes its volume by action of a high-pressure piston which is driven by an outer force,
wherein the high-pressure piston has a piston non-return valve mounted in its forehead, to allow the water passage across a high-pressure piston conduit into a compression chamber,
wherein a recirculation piston having a larger operating area than that the high-pressure piston to which is attached and is moveable simultaneously with it, where the recirculation piston divides the space of an inner casing wall into two chambers, the compression chamber situated beneath the recirculation piston and an upper chamber situated above the recirculation piston,
wherein the recirculation piston has one or more non-return valves to allow the water passage from the upper chamber to the compression chamber,
wherein simultaneous stroke-up of the recirculation piston and the high-pressure piston causes the intake of the water into the intake chamber through the inlet non-return valve and simultaneous decrease of the upper chamber volume, wherein simultaneous stroke-down action of the recirculation piston and the high-pressure piston causes an increasing of the intake chamber pressure and the water from the intake chamber is injected through the piston non-return valve and the high-pressure piston conduit into the compression chamber which volume is lowering due to the recirculation piston movement that forces a water flow from the compression chamber across the one or more prefilters and the filter, causing at the same time an intake of the concentrate from the recirculation chamber into the upper chamber,
wherein the upper chamber is further equipped with a concentrate discharge valve, and
wherein a permeate is guided out of the filter by a permeate drainage to the permeate outlet.

14. The method according to claim 13, further comprising using the water filtering system, said using including:
during the stroke-up movement the recirculation piston, empty the upper chamber and force a reverse circulation through the membrane and the one or more prefilters back to the compression chamber.

15. The method according to claim 13, further comprising using the water filtering system, said using including:
equalizing pressure between the compression chamber and the upper chamber, during the stroke-up movement, using one or more non-return valves associated with the recirculation piston.

16. The method according to claim 13, further comprising using the water filtering system, said using including:
recirculating the concentrate back into the upper chamber using one or more recirculation apertures in the upper chamber.

17. The method according to claim 13, further comprising using the water filtering system, said using including:
discharging concentrate, using the concentrate discharge valve, responsive to reaching a predetermined pressure within the upper chamber.
